(19) United States
(12) Patent Application Publication
(10) Pub. No.: US 2010/0187994 A1
(43) Pub. Date: Jul. 29, 2010

(54) HIGH-PRESSURE DISCHARGE LAMP

(75) Inventors: Paul Braun, Meitingen (DE); Roland Huettinger, Kaufering (DE); Klaus Stockwald, Germering (DE); Stefan Juengst, Zorneding (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/678,761

(22) PCT Filed: Aug. 12, 2008
(86) PCT No.: PCT/EP08/60581

§ 371 Date: Mar. 18, 2010

(30) Foreign Application Priority Data
Sep. 19, 2007 (DE) 20 2007 013 119.4

(51) Int. Cl. H01J 61/36

(52) U.S. Cl. 313/623

(57) ABSTRACT

The invention relates to a high-pressure discharge lamp, having a ceramic discharge vessel comprising a capillary (5) on the end. An electrode system is incorporated into the capillary, said electrode system having a three-part bushing (6). The bushing comprises a first, front-end part (15) in the shape of a pin, a center part comprising a core pin (16) and a Mo-winding (17), and an outer part that is a niobium pin (18). Each of the three parts has a different gap width.

### TECHNICAL FIELD

The invention is based on a high-pressure discharge lamp in accordance with the precharacterizing clause of claim 1. Such high-pressure discharge lamps are equipped with a ceramic discharge vessel.

### PRIOR ART

EP 1 211 714 has disclosed a high-pressure discharge lamp, in which an electrode system is inserted into the capillary of a ceramic discharge vessel. In this case, in order to avoid a variation in the color temperature, the capillary is designed in such a way that it is formed integrally with the discharge vessel and has a defined radius of curvature at the edge between the capillary and the inner volume. However, such a design is relatively complex and does not reduce the degree of variation of the color temperature to a sufficient extent.

EP 587238 has disclosed a three-part leadthrough with a central part having a reduced diameter. It is a W pin, whose length approximately corresponds to one third of the capillary length. The glass solder extends over the entire length of the central part.

### DESCRIPTION OF THE INVENTION

The object of the present invention is to prevent depletion of the fill in the discharge vessel and to improve the stability of the color temperature over the life in the case of a high-pressure discharge lamp.

This object is achieved by the characterizing features of claim 1.

Particularly advantageous refinements are given in the dependent claims.

In principle there is the problem of the capillary not being separated from the discharge vessel. The fill in the discharge vessel can retreat into the free spaces between the electrode system and the inner wall of the capillary, the so-called dead volume. This then results firstly in depletion of the fill and secondly in a type of distillation effect, which changes the fill in the discharge volume. This leads to an instability and change in the color temperature during operation and over the life. Conventionally, therefore, attempts are made to minimize or displace the dead volume as much as possible from the outset. The variance of the color temperature when using cerium-containing fills is particularly critical. Constricting the color temperature variance is also desirable in the case of fills with other metal halides such as holmium, dysprosium or thulium, however.

FIG. 6 shows the conventional variance of the color temperature as a function of the operating time.

A preferred fill for the novel teaching is a mixture of iodides of sodium, calcium, thallium and of cerium. Conventional proportions are an NaI content of from 50 to 70 mol %, a CaI₂ content of approximately 25 to 35 mol % and a TlI content of 1 to 5 mol % as well as a Ce₂I₃ content of 1 to 5 mol %.

The latter halide has a very pronounced influence on color temperature and lumen maintenance as a green-emitting component. Since it is only present in a small quantity in the discharge vessel, the position of the cerium halide in the discharge vessel is of decisive importance. A direct consequence is that recondensation of the liquid cerium iodide content can result in considerable variance in the color temperature. The recondensation as such can never be avoided since each lamp has a certain temperature gradient. The most severe gradient occurs at the transition to the capillary.

In this region, the fill or individual parts thereof evaporate and condense continuously. In particular in the vertical operating position, with the base pointing upwards, in the case of the previously known design of the lamp the condensed droplets of the fill are combined and flow into the capillary as far as the Mo coil. They are sucked into the coil there. The reason is that the coil is hotter and therefore the coverage is better on the inner wall of the capillary. In addition, capillary forces also play a role, and these capillary forces are more pronounced in the interior of the coil owing to the small cavities than at the capillary inner wall. A heat pipe effect is produced thereby, with the condensed fill again migrating back into the hot part, evaporating there again and condensing again in the rear area of the electrode. Then, the cycle begins again. If, on the other hand, attempts are made to avoid the Mo coil, the seal at the end of the capillary rapidly loses its sealtightness.

The vapor pressure of the cerium iodide depends to a considerable extent on the temperature. It is substantially greater in the hot rear area of the electrode than in the cold dead space of the capillary. Since the vapor pressure of the cerium iodide and therefore the quantity of vaporized substance has a very considerable influence on the color temperature, the time profile of the just-described cycle process on the basis of a heat pipe effect also has a considerable influence on the color temperature. In the case of these fills, the color temperature rises, as a result of the green emission of the cerium iodide, if there is more fill in the hot part. In the cold part, the vapor pressure and the green emission decreases, and therefore the color temperature also decreases. This time profile over 500 hours is shown in FIG. 6. The spikes illustrated can be ignored since these are merely of the effects which occur for a short period of time each time the lamp is switched on. The color temperature varies approximately in a range of between 3100 K and 2800 K, i.e. over a range of 300 K.

This variance of the color temperature relates to a lamp with a conventional seal. As shown in FIG. 5, this lamp uses a leadthrough 26 with an Mo pin 27 and an Mo coil 28 pushed thereon as the first part. The end 29 of the leadthrough is manufactured from niobium wire. The gap along the Mo coil is approximately 60 μm.

In accordance with the invention, a leadthrough system is now used which includes three parts. In this case, the front-side part pointing towards the discharge includes a pin made from Mo or predominantly from Mo, for example an alloy with an Mo content of 50% and further contents selected from the group consisting of rhodium, iridium and rhenium alone or in combination. The length L1 is approximately 50 to 70% of that part of the leadthrough which is located in the capillary with a total length LG. A system including a core pin and an Mo coil is used as the central part of the leadthrough, with the core pin consisting predominantly or exclusively of Mo in this case too. The length of the central part is approximately 15 to 30% of the total length LG. At one end, a pin consisting of niobium adjoins said central part, as is known per se. Its depth in the capillary corresponds to approximately 20 to 30% of LG. In this case, it is important that the gap width of the first part is relatively small and is at most 30 μm. The gap width of the central part can be selected to be relatively large; it is from 40 to 80 μm. The gap width of the niobium pin should again be selected to be narrower; it is from 25 to 45 μm.

A conventional glass solder extends from the outer rim of the capillary inwards. It should cover the niobium pin completely. A reliable seal can be achieved if the solder extends over a length of approximately 3 to 4 turns of the Mo coil. A typical fuse-seal length is in this case 1 mm.

### BRIEF DESCRIPTION OF THE DRAWINGS

The invention will be explained in more detail below with reference to a plurality of exemplary embodiments. In the figures:

FIG. 1 shows a schematic of a metal halide lamp;

FIG. 2 shows a novel embodiment of the end region;

FIG. 3 shows the fluctuation in the color temperature in the case of novel lamps;

FIG. 4 shows a further exemplary embodiment of the end region;

FIG. 5 shows the fluctuation in the color temperature in the case of conventional lamps;

FIG. 6 shows a detail of the end region in conventional lamps.

### PREFERRED EMBODIMENT OF THE INVENTION

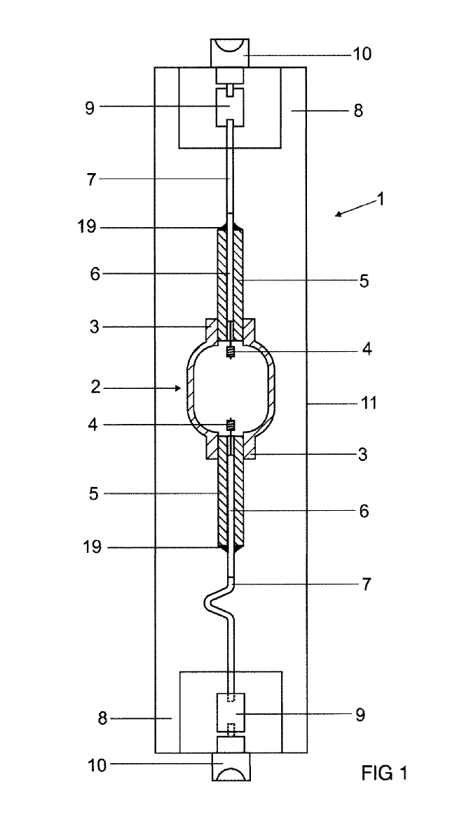

An exemplary embodiment of a metal halide high-pressure discharge lamp 1 is shown in FIG. 1. It has a ceramic discharge vessel 2, which is sealed at two ends. It is elongated and has two ends 3 with seals. Two electrodes 4 are positioned opposite one another in the interior of the discharge vessel. The seals are in the form of capillaries 5, in which a leadthrough 6 is sealed off by means of glass solder 19. In each case the end of the leadthrough 6 which is connected in a known manner on the discharge side to the associated electrode 4 protrudes out of the capillary 5. This leadthrough is connected to a base contact 10 via a power supply line 7 and a pinch seal 8 with a foil 9. The contact 10 is positioned at the end of an outer bulb 11 surrounding the discharge vessel.

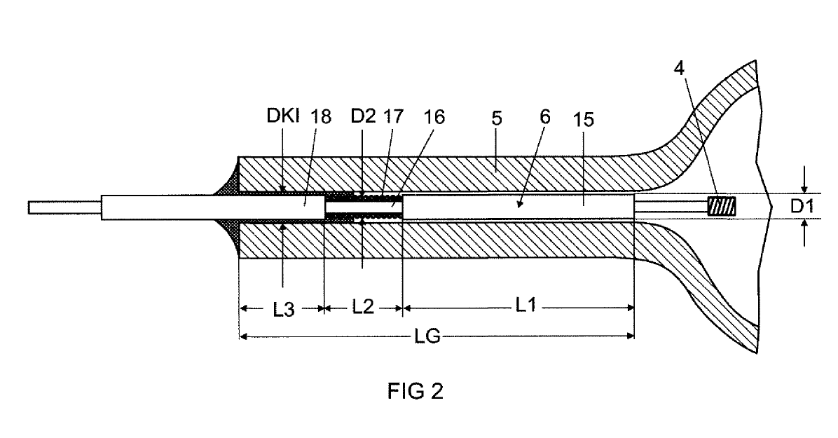

FIG. 2 shows the end region in detail for a 70 W lamp. The capillary 5 is in this case attached integrally to the discharge volume. The capillary has an inner diameter DKI of 800 μm, which is selected such that the electrode system just fits in. The leadthrough 6 includes 3 parts. The first part 15, which points at the front side towards the electrode 4, is an Mo pin with a diameter D1 of 770 μm. It has a length L1 of 7 mm. At the front, the shaft of the electrode 4 is fastened thereto. Towards the outside, the pin 15 is adjoined by a system including an Mo core pin 16 and an Mo coil 17 pushed thereon, whose outer diameter D2 is 680 μm, at a length of L2=2.5 mm. This is adjoined by a niobium pin 18 with a diameter of 730 μm. Its insertion depth L3 into the capillary is 2.6 mm. In general, L2 and L3 should be approximately the same size and should together make up approximately 30 to 50% of the length LG of the total part of the leadthrough which is located in the capillary.

The glass solder 19 is attached on the outside at the end of the capillary and extends inwards approximately to such an extent that it covers the entire inserted part of the niobium pin 18 and a small part of the Mo coil 17. Preferably, it covers approximately 3 to 4 turns of the coil 17 given a typical axial length of 1 mm.

The gap towards the capillary in the region of the first part 15 of the leadthrough is sufficiently small to prevent the fill from passing into the capillary. It has a gap width of typically 15 μm. This is also sufficiently small to suppress the heat pipe effect. An equilibrium is established very quickly. Secondly, the short sealing length of the glass solder on the Mo coil prevents cracks in the glass solder from being capable of resulting in a leak.

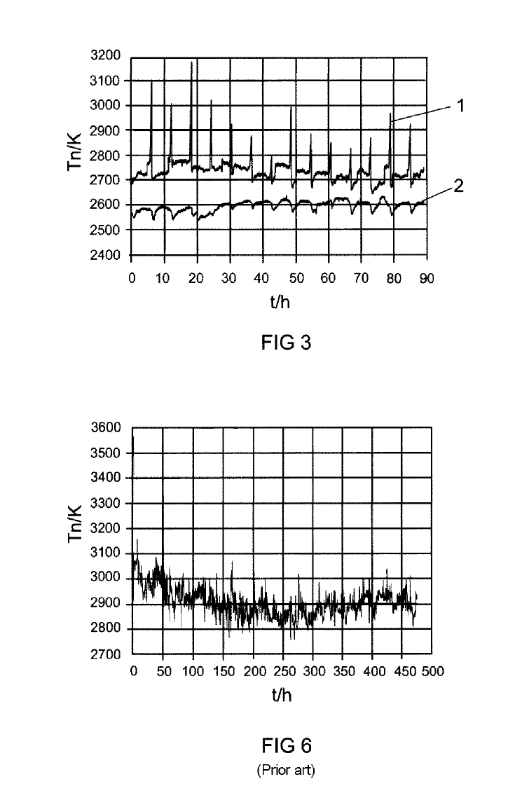

FIG. 3 shows the color temperature fluctuation for such a lamp. The color temperature Tn now only varies in a range of approximately 100 K. In this case, too, the spikes can again be ignored. FIG. 3 shows the ratios in the case of two differently selected fills with a color temperature of 2660 and 2700 K, respectively. In this case, the color temperature of the fill (1) fluctuates approximately between 2660 and 2770 K, while that of the fill (2) has a variance of between approximately 2550 and 2630 K.

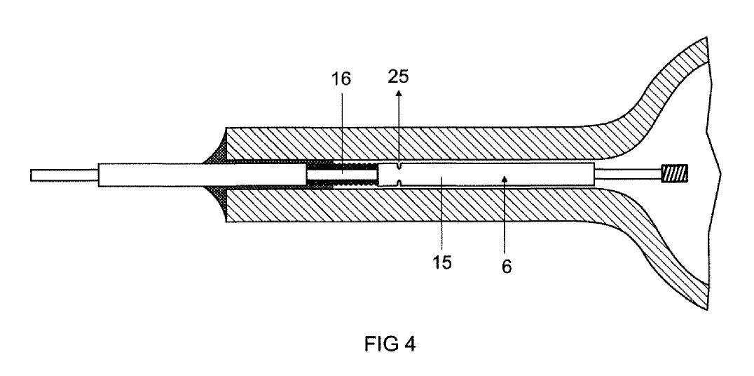

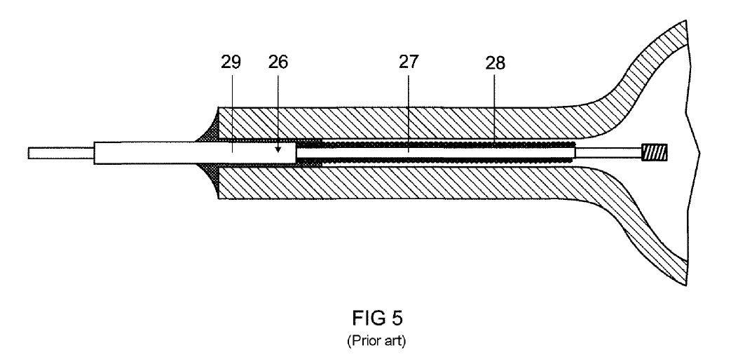

Finally, FIG. 4 shows a particularly preferred embodiment of the leadthrough 6, in which a narrow heat accumulation groove 25 runs circumferentially at the end of the first part 15 in the vicinity of the second part 16. A typical notch depth for the groove 25 is of the order of magnitude of from 50 to 100 μm. Thus, the heat flow along the solid first part is reduced and therefore the load on the seal, which is based on glass solder, is reduced. Preferably, the groove should be arranged in the rear third of the Mo pin 15.

A known glass solder is suitable as the glass solder (see WO 2005/124823, for example).

Any known metal halide fill is suitable as the fill for the discharge vessel. However, the system is particularly suitable for fill systems which contain a halide of cerium. For example, it is possible to use a fill such as in WO9825294, U.S. Pat. No. 6,525,476, WO9928946.

Instead of niobium, another niobium-like material can also be used, as mentioned in EP 587238.

1. A high-pressure discharge lamp, comprising:
an elongated, ceramic discharge vessel with a metal halide fill, with
an electrode being sealed off at the ends of said discharge vessel by means of a leadthrough in a capillary which has a given inner diameter, the leadthrough comprising three parts,
wherein the leadthrough comprises a pin made predominantly from Mo as the first, front-side part, whose diameter leaves a gap of at most 20 μm with respect to the capillary and whose length is from 50 to 70% of the total length of that part of the leadthrough which is located in the capillary, and a central part comprising a core pin, which is made predominantly from Mo and a coil consisting of Mo applied thereto, whose diameter leaves a gap of from 40 to 80 μm with respect to the capillary and whose length makes up from 15 to 30% of the total length, and a niobium pin, which is located at the end and whose diameter leaves a gap of from 25 to 45 μm with respect to the capillary, the length of that part of the niobium pin which is located in the capillary making up approximately from 20 to 35% of the total length, the leadthrough being covered by means of a glass solder, which extends from the outside over a plurality of turns of the Mo coil.

2. The high-pressure discharge lamp as claimed in claim 1, wherein the front-side Mo pin has a circumferential groove at its end facing the central part.

3. The high-pressure discharge lamp as claimed in claim 1, wherein the fill contains a halide of cerium.

4. The high-pressure discharge lamp as claimed in claim 1, wherein the discharge vessel and the capillary are designed to be integral.
